(19) United States
(12) Patent Application Publication
(10) Pub. No.: US 2017/0136685 A1
(43) Pub. Date: May 18, 2017

(54) METHOD TO INSTALL A WEAR-RESISTANT POLYMER SLEEVE IN A METAL PIPE BEND STIFFENER

(71) Applicant: PETROLEO BRASILEIRO S.A. - PETROBRAS, Rio de Janeiro (BR)

(72) Inventors: Alexandre Soares RABELO, Rio de Janeiro (BR); Volney Soares LOPES, Rio de Janeiro (BR); Antonio Marcos Rego MOTTA, Rio de Janeiro (BR)

(73) Assignee: PETROLEO BRASILEIRO S.A. - PETROBRAS, Rio de Janeiro (BR)

(21) Appl. No.: 15/354,049

(22) Filed: Nov. 17, 2016

(30) Foreign Application Priority Data
Nov. 18, 2015 (BR) 10 2015 028933-2

(51) Int. Cl. B29C 63/48; B29C 63/26; B29C 63/00

(52) U.S. Cl. CPC B29C 63/481; B29C 63/0004; B29C 63/0052; B29C 63/486; B29C 63/26; B29K 2075/00

(57) ABSTRACT

This invention offers a method to install a wear-resistant polymeric sleeve in a pipe bend stiffener with a metal inner wall, including the following steps: calculate thickness of the internal wall of the stiffener that can removed; remove the thickness of at least a portion of the calculated inner wall; and apply a polymeric material sleeve in the inner wall of the stiffener, where the polymeric material sleeve has the thickness of the inner wall removed.

### INVENTION FIELD

This invention is for a method to install a wear-resistant polymer sleeve in pipe bend stiffeners (risers).

### BASIS OF THE INVENTION

Usually, to connect a pipe (riser) to an oil platform, bend stiffeners are used to reduce damage to the pipes and to reduce the chance of possible failures. This needs to be done, since the pipes used are flexible and when they are directly connected to the platform, they cause concentrated tension at the connection point.

Thus, a bend stiffener is a device used in flexible risers (pipes and umbilicals) to smooth the sharp transition in rigidity at the interface with the oil platform, where the more rigid bend stiffener is assembled around the riser, at its upper end.

During riser installation, the stiffener is attached to the platform by a component called a bell-mouth. The riser is then slipped from inside the stiffener to a connector attached to the upper end of the riser, until it reaches the point where it is attached to the platform. This configuration makes the stiffener serve as support for the riser when it approaches the platform, substantially limiting its movement and, consequently, reducing efforts at the point where it is connected to the platform.

Note that once the riser goes through the inside of the stiffener, not necessarily being attached to this component, because of the platform's movement the riser stretches and contracts, thus generating friction between the outer surface of the riser and the inner surface of the stiffener.

In the first stiffener models, still in operation, the inner surface is in contact with steel, which causes accelerated wear on the outer casing of the risers, and it is more critical when there are corrosion spots, not uncommon in this type of structure. In addition to damaging the outer casing, which allows sea water to come in, prolonged friction can cause damage to the riser's traction armor, which in advanced stages can lead to its rupture.

To reduce the wear described, some stiffener models are made of polymeric material and their internal surface is covered with a polymeric layer. In both cases, the use of polymeric material has the main function of reducing the friction between the metal stiffener and the riser. Examples of such solutions are described in various documents, as will be shown below.

Document AU2005259096B2 shows a stiffener for flexible sea pipes, where the stiffener is adapted in order to limit the pipe's bending movement. The stiffener further includes a deformable rigid rod embedded in the width of said stiffener, in order to help measure deformation of the pipe and of the stiffener, using sensors.

Document AU2005259096B2 further states that the stiffener is made of a material, such as polyurethane, that is more rigid than the flexible pipe so as to reduce the bending of said pipes.

Document GB2492109A shows a stiffener, possibly for use in a riser, including two identical and opposite parts. Each of these parts may comprise a tapered cross-section where the parts are joined by strips that fit into recesses, so that the two halves of the stiffener are preferably made of polyurethane.

Document U.S. Pat. No. 6,220,303B1 shows a stiffener device to limit the bending angle of a flexible pipe, especially risers that are connected to oil platforms. In particular, the stiffener has an internal diameter which is larger than the diameter of the riser, so that the stiffener is able to slide along the riser.

In addition, document U.S. Pat. No. 6,220,303B1 provides for the use of a support element, which is positioned around the riser, with a diameter which is equal to the diameter of the riser so as to exert pressure and secure itself to the riser. Likewise, the inner diameter of the stiffener is slightly greater than the diameter of the support element so that, when there is no bending, the stiffener can slide along the support element. The three main elements described (stiffener, support element and riser) are joined at one end in order to keep them in the desired position. The support element can also be made of different plastic materials, such as polyurethane, elastomeric plastics or thermoplastics.

Meanwhile document U.S. Pat. No. 7,069,958B2 shows a stiffener extending on a portion of a flexible pipe in which an adapter is attached to the stiffener and extends over another portion of flexible pipe while maintaining the spacing thereof, forming an annular crown.

In addition, the device shown in document U.S. Pat. No. 7,069,958B2 is a cylindrical insert positioned between the adapter and the flexible pipe so that the cylindrical insert is in contact with the outer wall of the pipe and the inner wall of the adapter, where the insert is made of polyurethane. To attach the insert at its position, flanges extend on the end of the adapter and are secured by elements screwed in on the end of the adapter.

However, even with the know-how from prior art stiffeners, they would all require at least one element of the riser/stiffener group to be replaced with a more modern option, since the dimensions of the new stiffeners can be different from those currently used. This would result in high costs to the oil industry.

Thus, it is clear that the prior art lacks a stiffener renewal method that allows for reworking a metal stiffener so that it is less damaging to the pipe (riser) inside.

### SUMMARY OF THE INVENTION

The main objective of this invention is to rework a method for pipe bend stiffeners (risers) without a liner (inner liner of a cylinder or pipe), namely with a metal inner wall, which would reduce wear from contact of the stiffener with the pipe (riser).

Thus, in order to meet this objective, this invention offers a method to install a wear-resistant polymeric sleeve in a pipe bend stiffener with a metal inner wall, the steps for which are: calculate a thickness value for the internal wall of the stiffener that it is likely to be removed; remove the calculated thickness of the inner wall; and apply a polymeric material sleeve in the inner wall of the stiffener, where the polymeric material sleeve covers the thickness of the removed inner wall.

### BRIEF DESCRIPTION OF THE FIGURES

The detailed description given below is for the accompanying figures and the respective reference numbers, representing the modalities of this invention.

FIG. 1 illustrates the metal part of a common stiffener, without an inner liner, used in the prior art.

FIG. 2 shows a FIG. 1 stiffener after undergoing the installation method of a wear-resistant polymeric sleeve of this invention.

### DETAILED DESCRIPTION OF THE INVENTION

First, note that the following description will start with the preferred embodiment of the invention. As will be apparent to one skilled in the art, however, the invention is not limited to this particular embodiment.

In addition, note that this report will use both the term pipe, as well as the term riser, to refer to the flexible line element. These terms are commonly used by anyone skilled in the art so that, indeed, the use thereof is not likely to cause confusion.

As discussed above, the use of pipes (risers) with stiffeners without liners, is well established in the prior art. However, due to friction between these elements, the pipe must be frequently inspected to assess the amount of wear to the outer layer, because normally the pipe suffers premature wear in the area in contact with the stiffener metal.

When wear becomes critical, namely there is a risk to the structural integrity of the pipe, a process called re-terminating must be performed, which basically consists of cutting a portion of the end of the flexible line (riser) and installing a new connector. However, when there is not sufficient length for this procedure, a new structure must be acquired and the damaged riser must be replaced.

Both solutions are expensive and do not solve the problem of pipe wear, they only renew the short service life of the element.

Another option would be to replace the stiffener without a liner with a new model, such as a stiffener with a polymeric liner. However, this solution is not always feasible, due to the large dimensional differences between the risers used and a new stiffener, in addition to the load limitations of the platforms on which the risers are installed. In addition, replacement of the stiffeners in question would be very costly.

Thus, this invention solves the prior art problem, so as to allow a metallic stiffener to be reworked, allowing for the installation of a sleeve with polymeric material inside. Thus, metal-riser friction is eliminated, since the polymeric material sleeve will be in contact with the riser, and not with the metal stiffener, reducing damage to the outer casing of the riser.

Thus, the installation of a polymeric sleeve in a metallic stiffener of an older model increases the useful life of the riser, reducing the rate of wear between the outer casing of the riser and the inner surface of the stiffener. Thus, loss of production due to re-termination or replacement of the riser is considerably reduced.

To this end, this invention provides a method to install a wear-resistant polymeric sleeve on a metallic pipe bend stiffener involving the following steps: calculate a thickness value of the internal wall of the stiffener that can be removed; remove the thickness of at least a portion of the calculated inner wall; and apply a polymeric material sleeve on the inner wall of the stiffener, where the polymeric material sleeve covers the thickness of the inner wall removed.

After various studies, it was possible to calculate the thickness of the inner wall of the stiffener that could be removed to apply the sleeve, so that, preferably, removal of thicknesses greater than 10 mm is required so that applying the sleeve directly on the inner surface of the stiffener is feasible.

This invention provides that the thickness of at least a portion of the inner wall of the stiffener is removed, and situations are provided for in which the thickness of the inner wall as a whole is removed at least in part, and situations where only one part of the inner wall has thickness removed.

Thus, the step of calculating the thickness of the internal wall of the stiffener that can be removed can determine the technical feasibility of the proposed modification, and the maximum thickness that can be removed from the internal diameter of the stiffener without compromising its mechanical strength was verified. For a more accurate assessment at this stage, the stiffener is optionally numerically modeled by a computational tool and its structure is analyzed by the finite elements method.

After calculating the thickness to be removed, and deciding that the stiffener can go through the process of removing thickness as described, it is dismantled and its parts are inspected to check the integrity of such components. In this step, the stiffener is disassembled component by component, and the possibility of reusing each part is assessed. In cases of very damaged components, such components are replaced.

Optionally, drawings are made of the new configuration of the stiffener, with the polymeric material sleeve. This drawing may include details on each component and the drawing of the already assembled final group.

Thus, the step of removing the thickness of at least a portion of the calculated inner wall is carried out. At this point, the stiffeners preferably go through a machining process, the complexity of which may depend on the geometry and finish specified for each case.

Optionally, in order to increase the strength of the stiffener, the elements undergo surface treatment of the metal parts to restore corrosion protection. At this stage, chemical and/or mechanical treatments (painting) can be applied to the still dismantled components, and these treatments may follow the type of coverage used in the original stiffener design.

Another option is to include a non-destructive testing step for the stiffener and/or polymeric material sleeve. In this step, the stiffener and/or polymeric material sleeve are subjected to traditional non-destructive testing such as: ultrasonic, liquid penetrant and/or other testing necessary to assess the integrity of manufactured or refurbished parts.

Thus, a step of applying a polymeric material sleeve in the inner wall of the stiffener is included, where the polymeric material sleeve covers the thickness of the removed inner wall. Optionally, a mold is manufactured and assembled inside the stiffener, so that after the polymer is cast and cured it will meet the planned dimensions of the polymeric material sleeve, without any adjustments after this step. Optionally, the polymeric material sleeve may be pre-manufactured, and simply adhered to the inner surface of the stiffener.

If the polymeric material sleeve is directly molded on the inner surface of the stiffener, the polymer, which may be polyurethane, is cast in the mold, and the temperature throughout the process is controlled to prevent any internal or surface imperfections and also to ensure perfect adherence of the polymeric material sleeve to the metal body of the stiffener.

After applying the polymeric material sleeve, all parts are properly brought together and assembled, following the torques recommended by the stiffener manufacturer. After assembly, the whole is measured, based on the values determined by the design drawings.

Finally, in order to guarantee the tracking process, documentation of all of the processes involved in reworking the stiffener are gathered. This documentation must include the detailed designs of the components, the assembly drawing, the certificate of the materials used to recreate parts considered necessary parts and other labor certificates and certificates for consumables used in the process.

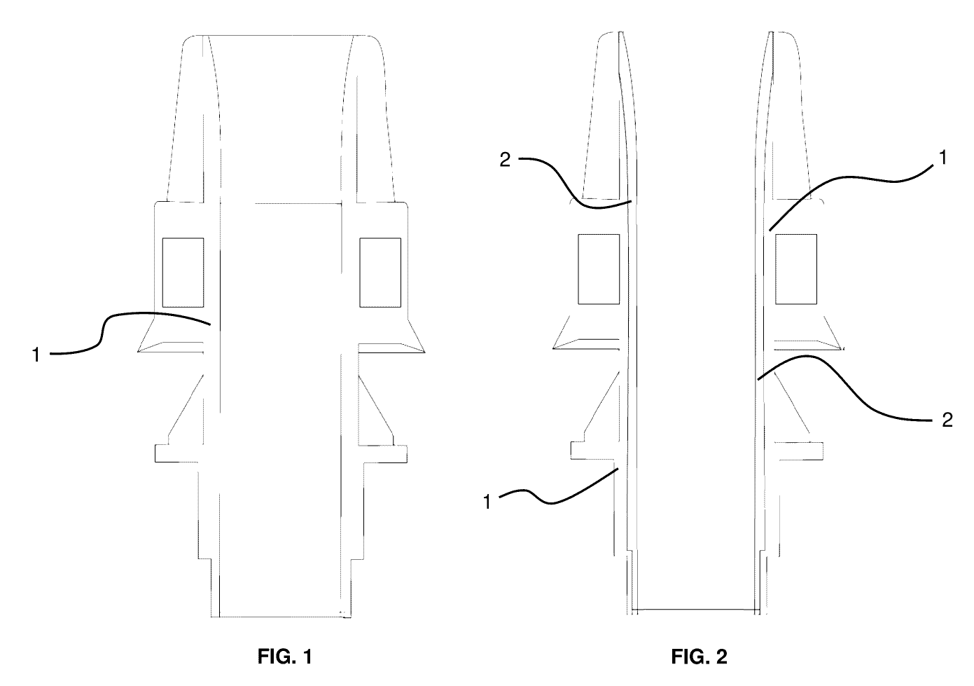

FIG. 1 shows a common metal stiffener 1, known from the prior art. FIG. 2 illustrates metal stiffener 1 in FIG. 1 after undergoing a method of installing a wear-resistant polymeric sleeve 2 in a metal pipe bend stiffener 1 of this invention. Note in FIG. 2, that stiffener assembly 1, polymeric material sleeve 2 does not show increased thickness when compared to stiffener 1 in FIG. 1.

Thus, it is clear that the installation method of a wear-resistant polymer sleeve in a metal pipe bend stiffener shown here resolves the problems of the prior art, allowing for refurbishing of a common metallic stiffener, reducing (or doing away with) metal/pipe friction without the high costs of replacing the entire stiffener.

1. Method to install a wear-resistant polymeric sleeve in a metal pipe bend stiffener, characterized by the following steps
calculate the thickness of the internal wall of the stiffener that can be removed;
remove the thickness of at least a portion of the calculated inner wall; and
apply a polymeric material sleeve in the inner wall of the stiffener, where the polymeric material sleeve covers the dimensions of thickness of the inner wall removed.

2. Method according to claim 1, characterized by including the step of treating the internal wall of the stiffener, before the step of applying the polymeric material sleeve to the internal wall of the stiffener.

3. Method according to claim 1, characterized by the step of calculating the thickness of the internal wall of the stiffener that can be removed, including
modeling the stiffener by a software tool, and
analyzing the stiffener structure by the finite elements method.

4. Method according to claim 1, characterized by the step of removing the calculated inner wall thickness including a machining process.

5. Method according to claim 1, characterized by including the step of replacing anticorrosive protection on the surface of the metallic stiffener that has undergone the step of removing the calculated thickness of the inner wall.

6. Method according to claim 1, characterized by including the step of performing a non-destructive test on at least one of the following: the metallic stiffener; and the polymeric material sleeve after the step of removing the calculated thickness of the inner wall.

7. Method according to claim 6, characterized by including non-destructive testing, including use of at least one of the following: ultrasound; and penetrating liquid.

8. Method according to claim 1, characterized by the polymeric material being polyurethane.

9. Method according to claim 1, characterized by the step of applying a polymeric material sleeve in the inner wall of the stiffener, including
manufacturing a mold for the polymeric material sleeve,
assembling the mold in the stiffener, and
casting a polymer in the mold, where the temperature throughout the process is controlled.

10. Method according to claim 1, characterized by a step to remove the calculated thickness of the inner wall, removing at least 10 mm of thickness of the inner wall of the metal stiffener.
